(19) United States
(12) Patent Application Publication
(10) Pub. No.: US 2025/0095519 A1
(43) Pub. Date: Mar. 20, 2025

(54) Anti-Tangle Device for Outrigger Flagpoles

(71) Applicant: Smoothly Ventures, LLC, Westerville, OH (US)

(72) Inventors: Andrew Bensen Leavitt, Westerville, OH (US); William Edward Staber, Canal Winchester, OH (US); Tyler Allen Bensen Leavitt, Westerville, OH (US)

(73) Assignee: Smoothly Ventures, LLC, Westerville, OH (US)

(21) Appl. No.: 18/889,624

(22) Filed: Sep. 19, 2024

Related U.S. Application Data
(60) Provisional application No. 63/583,666, filed on Sep. 19, 2023.

(51) Int. Cl. G09F 17/00

(52) U.S. Cl. CPC G09F 17/0091; G09F 2017/0008; G09F 2017/0058

(57) ABSTRACT

A device suppresses a flag from wrapping around a flagpole flying such flag. The device has an upstanding leg carrying rings adapted to surmount a flagpole and is adapted to grasp an edge of a flag. The device also has a laterally extending leg that extends to around the middle of the flag and is adapted to grasp an edge of a flag. A stop plate is affixed to the upstanding leg. A flag fixed to the device is suppressed from wrapping around a flagpole carrying the device.

### CROSS-REFERENCE TO RELATED APPLICATIONS

Not applicable.

### STATEMENT REGARDING FEDERALLY SPONSORED RESEARCH AND DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM

Not applicable.

### STATEMENT REGARDING PRIOR DISCLOSURES BY THE INVENTOR OR A JOINT INVENTOR

Not applicable.

### BACKGROUND OF THE INVENTION

The present disclosure relates to outrigger flagpoles and more particularly to a device

to prevent a flag flown on an outrigger flagpole from becoming “tangled”, that is, wrapped around the flagpole.

It is common practice for citizens and businesses to fly a flag, generally, in front of a house or business. It also is common for the flag to wraparound the flagpole under the influence of winds and especially high winds. While this may frustrate a homeowner, the flag can be unwound easily.

But consider flags flown by commercial and industrial businesses. Hotels, for example, may fly several flags. Often, such flags can be quite large and/or several feet off the ground. Unwinding those flags can require the employment of a company having a “Bucket Truck Service” or similar equipment which can provide access to personnel to unwind the flag. Consider the frustration when a business has to deal with this problem on a daily basis and for a plurality of flags.

It is to this problem that the present invention is addressed.

### BRIEF SUMMARY OF THE INVENTION

The disclosed device has an upstanding leg carrying rings adapted to surmount a flagpole and is adapted to grasp an edge of a flag.

There are 3 components that work together to make the anti-tangle/wrap work together as one: (1) a rigid frame; (2) rings; and (3) a stop plate. The rigid frame keeps the flag in a solid frame to control flag movement. The rings allow the flag attached to the rigid frame to flow the entire circumference of the outrigger flagpole with the wind without binding. The stop plate, attached to the outrigger flagpole using set fasteners (e.g., set screws) keeps the flag that is attached to the rigid frame at full staff.

The device also has a laterally extending leg that extends to around the middle of the flag and is adapted to grasp an edge of a flag. A flag fixed to the device is suppressed from wrapping around a flagpole carrying the device.

### BRIEF DESCRIPTION OF THE SEVERAL VIEWS OF THE DRAWINGS

For a fuller understanding of the nature and advantages of the present method and process, reference should be had to the following detailed description taken in connection with the accompanying drawings, in which:

FIG. 1 is a front view of a flag outfitted with the disclosed device;

FIG. 2 is an isometric view of the disclosed device affixed to a flag;

FIG. 3 is a top view of a flag and device of FIG. 2; and

FIG. 4 is an isometric view of the upstanding leg portion of the disclosed device;

FIG. 5 is an isometric view of a stop ring or stop plate; and

FIG. 6 is an isometric view of the flag attachment assembly.

The drawings will be described in more detail below.

### DETAILED DESCRIPTION OF THE INVENTION

The new flag anti-tangle device finds especial favorability for large flags displayed in numbers on the front facade of a commercial building; although, the size of the device can be larger or smaller to accommodate different sized flags. The new flag anti-tangle device finds acceptance for flags flown horizontally, vertically, and at any angle therebetween.

Referring to the drawings, a flag, 10, having a flag surface and a perimeter creating an outer boundary for the flag surface is seen in an unfurled state. The disclosed device is seen to include an upstanding leg, 12 (also referred to herein as a first leg), and a laterally extending leg, 14 (also referred to herein as a second leg). Flag 12 is intimately attached to both legs 12 and 14. Such intimate attachment prevents flag 10 from wrapping around any flagpole due to wind movement.

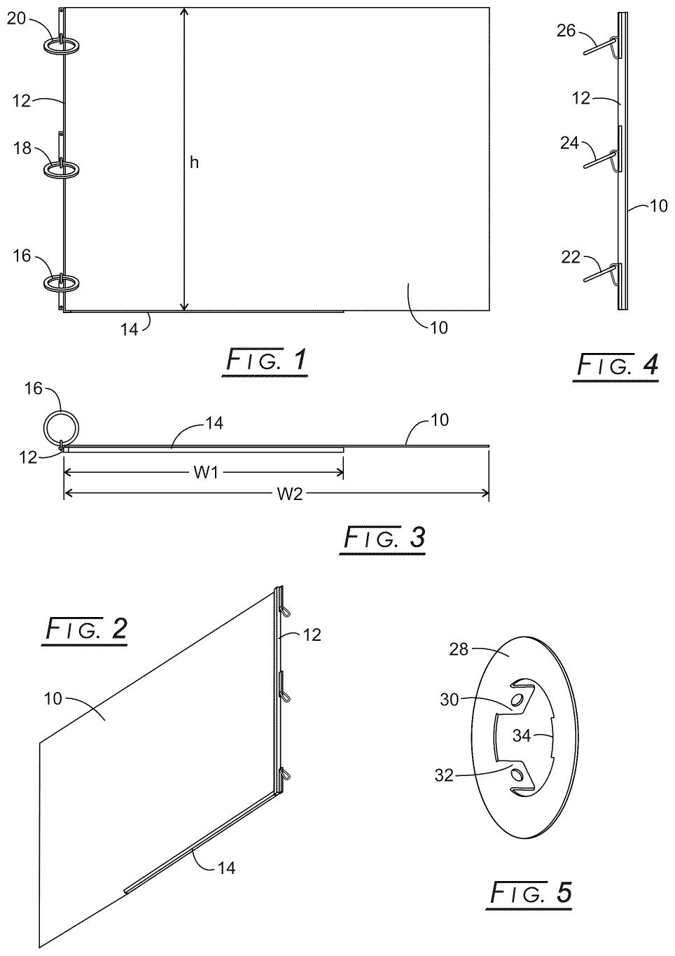

Upstanding leg 12 in FIG. 1 is only intermittently seen in order to enhance the view of the flagpole rings, 16, 18, and 20, that surmount a flagpole carrying flag 10. The flagpole rings attach to upstanding leg 12. Additionally, upstanding leg 12 carries 3 short stabilizing legs, 22, 24, and 26, that urge flag 10 to remain taught along upstanding leg 12 and provide for the flag to be attached to leg 12 via the use of carabiner clips, as is more fully developed in FIG. 7.

According to certain aspects of the present teaching, laterally extending leg 14 runs to a somewhat central position along the bottom edge of flag 10. The disclosed device permits the top and a portion of the bottom of flag 10 to blow in the wind as would a flag lacking the disclosed device. A flag moving by the wind is known to be aesthetically pleasing. Accordingly, the laterally extending leg may have a length that extends half a length of or about half a length of a bottom edge of the flag. However, it is to be understood that the laterally extending leg may also have a length that extends 1) less than half a length of a length of a bottom edge of the flag, 2) greater than half a length of a bottom edge of the flag, or 3) up to the entire length of a bottom edge of the flag.

According to one aspect of the present teaching, flag 10 is held by legs 12 and 14 for the anti-tangle device to properly function. One such way is to run the side and bottom edges of flag 10 into slots formed in legs 12 and 14. This mode of attachment militates against legs 10 and 12 being a one-piece device. Alternately, clips of other securing items could be used to secure intermittent attachment of flag 10 to legs 12 and 14. Should the two legs carry such clips, the two legs could be connected together as a single unit. Accordingly, the upstanding leg and the lateral leg may or may not be engaged to each other depending on the embodiment. The upstanding leg and the lateral leg may also be positioned perpendicular or substantially perpendicular with respect to each other (i.e., at an angle of 90 degrees or about 90 degrees) or may be positioned at any angle less than or greater than 90 degrees with respect to each other. Of course, the skilled artisan may conceive of other ways for the two legs to carry flag 10.

Typical flags can be found ranging in size from 3×5 feet, 4×6 feet, 5×8 feet, and 6×10 feet flags. This translates into heights, h, ranging from 3 to 6 feet and widths, w2, ranging from 5 to 10 feet. It should be understood that any other sized flags may be carried by the disclosed device by suitable size alteration of the components of the anti-tangle device.

The length, w1, of laterally extending leg 14 is such that its end will be around the middle of the flag bottom edge although longer and shorter lengths will function. The length, w1, of laterally extending leg 14 is such that sufficient free length will still create a pleasing “waving” effect on windy days. Of course, the longer w1 is the less likely of any wrapping of the flag around the flagpole there will be, however, such longer lengths suppress the aesthetic waving of the flag.

Considering an alternative perspective of the anti-tangle device, the flag and the flagpole, the perimeter of the flag has a first point nearest the flagpole, and a second point positioned farthest from the flagpole. The first point lies on a first line on the flag that is parallel to the flagpole longitudinal axis and the second point lies on a second line on the flag that is parallel to the flagpole longitudinal axis. The first line and the second line on the flag are separated by a distance D1. A first area of the flag surface may be defined as including a portion of the flag surface positioned between the flagpole longitudinal axis and a third line on the flag that is parallel to the flagpole longitudinal axis and equidistant from the first line and the second line on the flag.

According to this perspective, at least a portion of the first leg may extend along a first portion of the first area of the flag surface and at least a portion of the second leg may extend along a second portion of the first area of the flag surface. The first attachment location on the flag may be within the first area of the flag surface and the second attachment location on the flag may be within the first area of the flag surface. The second attachment location may further lay on a fourth line that is parallel to the flagpole longitudinal axis. The fourth line may be separated from the flagpole axis a distance D2, wherein D2 is at least (D1)/4. In other embodiments, the fourth line may be separated from the flagpole a distance D2, wherein D2 is at least (D1)/3. In further embodiments, the fourth line may be separated from the flagpole a distance D2, wherein D2 is (D1)/2, about (D1)/2 or greater than (D1)/2.

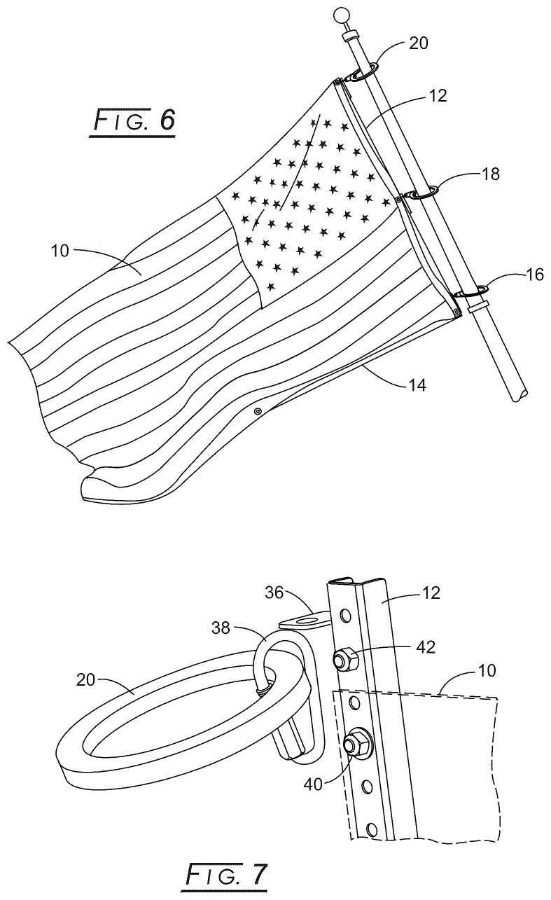

In order to keep the flag with anti-tangle device at full stop, reference is made to FIG. showing a stop plate or stop ring, 28, that surmounts the flagpole as do rings 16-20. Stop plate 28 may have at least one or a plurality of set tabs, 30, 32 and 34, each having a corresponding set tab hole through which set fasteners (e.g., set screws or any other type of suitable fastener) are placed and engaged to the flagpole. The set tab holes may or may not be threaded. In some cases, the stop plate 28 includes three set tabs. Of course, the number of tabs could be greater or lesser in number. According to certain aspects of the present teaching as shown in FIG. 6, the stop plate functions to provide a resting place for a ring attached to the flagpole and to the upstanding leg, thereby preventing the anti-tangle device from falling down the side of the flagpole to the ground.

The details of the attachment of the flag to upstanding leg 12 are set forth in FIG. 7. Leg 12 has at least one hole to accommodate its engagement to a flag and may have a plurality of holes to accommodate flags of various sizes. Flags typically are purchased with a pair of grommets along one side of the flag for attachment of the flag to a flagpole. At least one nut and bolt assembly, 40, affixes to the flag (e.g., a corner of the flag) through the flag grommet. One or more spare nut and bolt assemblies, 42, may be provided, as illustrated for additional securement of the leg 12 to the flag. The same procedure is followed for the other corner grommet. If an intermediate attachment is needed, the installer can use a kit to create one or more intermediate grommet between the original grommets for additional attachment and securement of flag 10 to leg 12. According to another aspect of the present teaching, the installer may create one or more grommets on the bottom perimeter of the flag to secure the flag to lateral leg 14 having a similar design and a similar attachment mechanism to upstanding leg 12 as described in this paragraph.

Also shown in FIG. 7 is the current attachment mechanism of the disclosed device to a flagpole. At least one tab, 36, is attached to upstanding leg 12 (whether by welding, bolting, or other technique). Tab 36 has a hole on its horizontal portion. Flagpole ring 20 is secured to tab 36 with a clip (e.g., a carabiner clip or any other suitable clip), 38, which clip is run through the tab 36 hole and ring 20; and then clip 38 is closed, for example, by using a threaded mechanism as is illustrated in FIG. 6. These tabs and carabiner clips can be seen in FIGS. 1 and 4 also. According to certain embodiments the leg 12 may include two or at least two tabs 36 as described above for securing a top and bottom portion of the leg 12 to the flagpole. In further embodiments, the leg 12 may include three or at least three tabs 36 as described above for securing a top, middle and bottom portion of the leg 12 to the flagpole. As noted above, however, a variety of additional methods for securing ring 20 and flag 10 to the disclosed device can be used to advantage.

Accordingly, the anti-tangle device capable of suppressing a flag from wrapping around a flagpole flying such flag includes (a) an upstanding leg carrying rings adapted to surmount a flagpole and adapted to grasping a first surface of a flag; (b) a laterally extending leg that extends to around an interior portion of the flag and is adapted to grasping a second surface of the flag that extends further from the flagpole than the upstanding leg; and a stop plate affixed to the upstanding leg and surmounting the flagpole to hold the anti-tangle device at full stop, whereby a flag is fixed to the device and is suppressed from wrapping around a flagpole carrying the device. The upstanding leg may carry at least one stabilizing leg (in some cases three stabilizing legs) secured to the flag (e.g., through the use of carabiner clips or any other suitable fastener) capable of applying tension to the flag to urge the flag to remain taught along the upstanding leg. The upstanding leg and the laterally extending leg may include a slot that is formed into the upstanding leg and the laterally extending leg that allows the legs to engage the edges of the flag. Alternatively, the upstanding leg and the laterally extending leg may use a plurality of clips to attach the legs to the edges of the flag. The laterally extending leg may have a length that extends half a length of or about half a length of a bottom perimeter of the flag.

In accordance with the disclosure set forth above, provided is a first embodiment of a flag anti-tangle device for use with an associated flag and with an associated flagpole having a longitudinal axis, the flag anti-tangle device including: a first leg that: a) is adapted to attach to the flagpole; and b) is adapted to attach to a first attachment location on the flag; a second leg that is adapted to attach to a second attachment location on the flag; and a stop plate that his adapted to attach to the flagpole; wherein when the first leg of the flag anti-tangle device is attached to the flagpole and to the first attachment location on the flag, the second leg is attached to the second attachment location on the flag, and the stop plate is attached to the flagpole and is engaged to the first leg; wherein the flag has (a) a flag surface; and (b) a perimeter creating an outer boundary for the flag surface; wherein the perimeter has (a) a first point positioned nearest the flagpole, and (b) a second point positioned farthest from the flagpole, wherein the first point lies on a first line that is parallel to the flagpole longitudinal axis and the second point lies on a second line that is parallel to the flagpole longitudinal axis, the first line and the second line being separated by a distance D1; wherein a portion of the flag surface positioned between the flagpole longitudinal axis and a third line that is parallel to the flagpole longitudinal axis and equidistant from the first line and the second line is defined as a first area of the flag surface; wherein at least a portion of the first leg extends along a first portion of the first area of the flag surface; wherein at least a portion of the second leg extends along a second portion of the first area of the flag surface; wherein the first attachment location on the flag is within the first area of the flag surface; wherein the second attachment location on the flag is within the first area of the flag surface; wherein the second attachment location lies on a fourth line that is parallel to the flagpole longitudinal axis; wherein the fourth line is separated from the flagpole axis a distance D2, wherein D2 is at least (D1)/4; wherein the stop plate holds the first leg in place at full stop preventing the flag anti-tangle device from moving down the flagpole; and wherein the flag anti-tangle device suppresses the flag from wrapping around the flagpole.

A second embodiment of the anti-tangle device includes any previous or subsequent embodiments, wherein the first leg is substantially parallel to the flagpole longitudinal axis.

A subsequent embodiment of the anti-tangle device includes any previous or subsequent embodiments, wherein the first leg carries rings adapted to surmount the flagpole and is adapted to grasping the first portion of the first area of the flag surface.

A subsequent embodiment of the anti-tangle device includes any previous or subsequent embodiments, wherein the second leg extends further from the flagpole than the upstanding leg.

A subsequent embodiment of the anti-tangle device includes any previous or subsequent embodiments, wherein the second leg is substantially perpendicular to the flagpole longitudinal axis.

A subsequent embodiment of the anti-tangle device includes any previous or subsequent embodiments, wherein the first attachment location on the flag is positioned on the flag's perimeter and wherein the second attachment location on the flag is positioned on the flag's perimeter.

A subsequent embodiment of the anti-tangle device includes any previous or subsequent embodiments, wherein the first leg and the second leg each comprise a slot that is formed into the first leg and into the second leg, wherein the slot on the first leg and the slot on the second leg are capable of engaging a portion of an edge on the perimeter of the flag.

A subsequent embodiment of the anti-tangle device includes any previous or subsequent embodiments, wherein the first leg and the second leg each comprise a plurality of clips capable of engaging corresponding clips attached to the perimeter of the flag.

A subsequent embodiment of the anti-tangle device includes any previous or subsequent embodiments, wherein the first leg carries at least one stabilizing leg that is capable of applying tension to the flag to urge the flag to remain taught along the first leg.

A subsequent embodiment of the anti-tangle device includes any previous or subsequent embodiments, wherein the flag is attached to the first leg and to the at least one stabilizing leg through the use of clips.

A subsequent embodiment of the anti-tangle device includes any previous or subsequent embodiments, wherein the stop plate comprises at least one set tab having a threaded hole within the screw tab for receiving a set fastener to secure the stop plate to the flagpole.

A subsequent embodiment of the anti-tangle device includes any previous or subsequent embodiments, wherein first leg includes a plurality of holes and at least one nut and bolt assembly, wherein the bolt passes through a hole in the first leg and through a grommet positioned on the first area of the flag and wherein the nut engages the bolt to secure the flag to the first leg.

A subsequent embodiment of the anti-tangle device includes any previous or subsequent embodiments, wherein the first leg includes a tab positioned horizontally with respect to the first leg, wherein the tab includes a hole, wherein the hole is capable of securing a flagpole ring to the upstanding leg.

A subsequent embodiment of the anti-tangle device includes any previous or subsequent embodiments, wherein the hole in the horizontally positioned tab of the first leg receives a clip, wherein the clip is engaged to the flagpole ring.

A subsequent embodiment of the anti-tangle device includes any previous or subsequent embodiments, wherein the hole in the horizontally positioned tab of the first leg receives a carabiner clip, wherein the carabiner clip is run through the tab hole and the flagpole ring and wherein the carabiner clip is subsequently closed to secure the flagpole ring to the first leg.

A subsequent embodiment of the anti-tangle device includes any previous or subsequent embodiments, wherein the carabiner clip comprises a threaded mechanism for opening and closing the carabiner clip.

A subsequent embodiment of the anti-tangle device includes any previous or subsequent embodiments, wherein D2 is at least (D1)/3.

A subsequent embodiment of the anti-tangle device includes any previous or subsequent embodiments, wherein D2 is (D1)/2 or about (D1)/2.

A subsequent embodiment of the anti-tangle device includes any previous or subsequent embodiments, wherein the upstanding leg and the laterally extending leg are not engaged to one another.

A subsequent embodiment of the anti-tangle device includes any previous or subsequent embodiments, wherein the upstanding leg and the laterally extending leg are engaged to one another.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

What is claimed is:

1. A flag anti-tangle device for use with an associated flag and with an associated flagpole having a longitudinal axis, the flag anti-tangle device comprising:
a first leg that:
a) is adapted to attach to the flagpole; and
b) is adapted to attach to a first attachment location on the flag;
a second leg that is adapted to attach to a second attachment location on the flag; and
a stop plate that his adapted to attach to the flagpole;
wherein when the first leg of the flag anti-tangle device is attached to the flagpole and to the first attachment location on the flag, the second leg is attached to the second attachment location on the flag, and the stop plate is attached to the flagpole and is engaged to the first leg;
wherein the flag has (a) a flag surface; and (b) a perimeter creating an outer boundary for the flag surface;
wherein the perimeter has (a) a first point positioned nearest the flagpole, and (b) a second point positioned farthest from the flagpole,
wherein the first point lies on a first line that is parallel to the flagpole longitudinal axis and the second point lies on a second line that is parallel to the flagpole longitudinal axis, the first line and the second line being separated by a distance D1;
wherein a portion of the flag surface positioned between the flagpole longitudinal axis and a third line that is parallel to the flagpole longitudinal axis and equidistant from the first line and the second line is defined as a first area of the flag surface;
wherein at least a portion of the first leg extends along a first portion of the first area of the flag surface;
wherein at least a portion of the second leg extends along a second portion of the first area of the flag surface;
wherein the first attachment location on the flag is within the first area of the flag surface;
wherein the second attachment location on the flag is within the first area of the flag surface;
wherein the second attachment location lies on a fourth line that is parallel to the flagpole longitudinal axis;
wherein the fourth line is separated from the flagpole axis a distance D2, wherein D2 is at least (D1)/4;
wherein the stop plate holds the first leg in place at full stop preventing the flag anti-tangle device from moving down the flagpole; and
wherein the flag anti-tangle device suppresses the flag from wrapping around the flagpole.

2. The device of claim 1, wherein the first leg is substantially parallel to the flagpole longitudinal axis.

3. The device of claim 2, wherein the first leg carries rings adapted to surmount the flagpole and is adapted to grasping the first portion of the first area of the flag surface.

4. The device of claim 3, wherein the second leg extends further from the flagpole than the upstanding leg.

5. The device of claim 4, wherein the second leg is substantially perpendicular to the flagpole longitudinal axis.

6. The device of claim 5, wherein the first attachment location on the flag is positioned on the flag's perimeter and wherein the second attachment location on the flag is positioned on the flag's perimeter.

7. The device of claim 6, wherein the first leg and the second leg each comprise a slot that is formed into the first leg and into the second leg, wherein the slot on the first leg and the slot on the second leg are capable of engaging a portion of an edge on the perimeter of the flag.

8. The device of claim 6, wherein the first leg and the second leg each comprise a plurality of clips capable of engaging corresponding clips attached to the perimeter of the flag.

9. The device of claim 6, wherein the first leg carries at least one stabilizing leg that is capable of applying tension to the flag to urge the flag to remain taught along the first leg.

10. The device of claim 9, wherein the flag is attached to the first leg and to the at least one stabilizing leg through the use of clips.

11. The device of claim 10, wherein the stop plate comprises at least one set tab having a threaded hole within the screw tab for receiving a set fastener to secure the stop plate to the flagpole.

12. The device of claim 11, wherein first leg comprises a plurality of holes and at least one nut and bolt assembly, wherein the bolt passes through a hole in the first leg and through a grommet positioned on the first area of the flag and wherein the nut engages the bolt to secure the flag to the first leg.

13. The device of claim 12, wherein the first leg comprises a tab positioned horizontally with respect to the first leg, wherein the tab comprises a hole, wherein the hole is capable of securing a flagpole ring to the upstanding leg.

14. The device of claim 13, wherein the hole in the horizontally positioned tab of the first leg receives a clip, wherein the clip is engaged to the flagpole ring.

15. The device of claim 14, wherein the hole in the horizontally positioned tab of the first leg receives a carabiner clip, wherein the carabiner clip is run through the tab hole and the flagpole ring and wherein the carabiner clip is subsequently closed to secure the flagpole ring to the first leg.

16. The device of claim 15, wherein the carabiner clip comprises a threaded mechanism for opening and closing the carabiner clip.

17. The device of claim 5, wherein D2 is at least (D1)/3.

18. The device of claim 6, wherein D2 is (D1)/2 or about (D1)/2.

19. The device of claim 5, wherein the upstanding leg and the laterally extending leg are not engaged to one another.

20. The device of claim 5, wherein the upstanding leg and the laterally extending leg are engaged to one another.
